(19) United States
(12) Patent Application Publication
(10) Pub. No.: US 2008/0136603 A1
(43) Pub. Date: Jun. 12, 2008

(54) LOW-POWERED RFID TAG AND METHOD OF EXPANDING LIFECYCLE OF RFID TAG

(75) Inventors: Su Na Choi, Daejeon-City (KR); Hae Won Son, Daejeon-City (KR); JunHo Yeo, Daejeon-City (KR); Jae Young Jung, Daejeon-City (KR); Jong Hyun Seo, Daejeon-City (KR); Gil Young Choi, Daejeon-City (KR); Cheol Sig Pyo, Daejeon-City (KR); Jong Suk Chae, Daejeon-City (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/875,493

(22) Filed: Oct. 19, 2007

(30) Foreign Application Priority Data
Dec. 8, 2006 (KR) 10-2006-0125021

(51) Int. Cl. H04B 7/00

(52) U.S. Cl. 340/10.33

(57) ABSTRACT

A battery-powered RFID tag capable of reducing power consumption and a method of waking up the RFID tag are provided. The battery-powered RFID tag has an activated mode where a general command is detected by decoding a signal received from an RFID tag reader and the general command is executed and a standby mode where the general command is not detected. If a voltage of a continuous wave detected from the signal is equal to or higher than a predetermined voltage or if a wake-up command is detected from the signal, the state of the RFID tag is changed from the standby mode to the activated mode. In addition, the RFID tag is driven by a higher one between the voltage of the continuous wave and a voltage of a built-in battery.

### CROSS-REFERENCE TO RELATED PATENT APPLICATION

This application claims the benefit of Korean Patent Application No. 10-2006-0125021, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a radio frequency identification (RFID) tag, and more particularly, to a battery-powered RFID tag having a wake-up unit capable of expanding lifecycle of a battery, a method of waking up an RFID tag, a power supply device for an RFID tag, and a method therefore.

This work was supported by the IT R&D program of MIC/IITA.[2005-S-106-02, Development of Sensor Tag and Sensor Node Technologies for RFID/USN]

2. Description of the Related Art

In a radio frequency identification (RFID) technology, an RFID tag containing identification (ID) unique to a product is attached to the product, and the ID is detected using a radio frequency (RF) device such as a RFID tag reader. Due to the RFID tag, information on the product can be collected, stored, processed, and traced. Accordingly, the products with the RFID tags attached can be remotely controlled and managed, and information can be communicated between the products. As a substitute for existing barcodes, the RFID tags have been used for product management and delivery, security, and other various fields. In addition, new markets associated with the RFID tags are expected to appear.

The RFID tags are classified into a passive RFID tag and a battery-powered RFID tag according to presence of a built-in battery for supplying power to the RFID tags. The passive RFID tag is driven using a continuous wave received from an RFID reader, and the battery-powered RFID tag is driven by the built-in battery.

FIG. 1 is a block diagram showing function blocks of a tag chip in a conventional passive radio frequency identification tag.

Referring to FIG. 1, the passive RFID tag includes an antenna 110 and a tag chip 120.

The tag chip 120 includes a voltage multiplier 125, a demodulator 140, a decoder 155, a controller 160, an electrically erasable programmable read-only memory (EEPROM) 165, a clock generator 175, an encoder 180, and a modulator 185.

The voltage multiplier 125 generates a DC voltage from a signal received from an RFID tag reader through the antenna 110 and drives the EEPROM and other internal components of the RFID tag using the DC voltage. In such a passive RFID tag, the DC voltage is proportional to a magnitude of the signal received from the RFID tag reader. Therefore, when the passive RFID tag is apart from the RFID tag reader by a predetermined distance (about 5 mm) or more, there is a problem in that it is difficult to generate a sufficient voltage.

On the contrary, in a battery-powered RFID tag with a built-in battery, power can be stably provided to internal components of the RFID tag. Therefore, a detection coverage of the battery-powered RFID tag is wider by 30 m or more than that of the passive RFID tag. However, the battery-powered RFID tag has a problem in that the lifecycle of the RFID tag depends on the lifecycle of the battery.

In such a battery-powered RFID tag, most internal components thereof are in a standby mode, that is, an inactivated mode in order to reduce power consumption. When a wake-up command is transmitted from the RFID tag reader, all the components of the RFID tag are activated to operate during a short time period. After a predetermined time interval, the RFID tag returns to the standby mode.

In the battery-powered RFID tag, circuits for detecting the wake-up command transmitted from the RFID tag reader need to operate although the RFID tag is in the standby mode. In addition, the time interval of the standby mode of the RFID tag is longer than that of the activated mode thereof. Therefore, the lifecycle of the battery-powered RFID tag greatly depends on currents for the circuits during the standby mode.

### SUMMARY OF THE INVENTION

The present invention provides an RFID tag having a wake-up unit capable of minimizing a standby current of circuits for detecting a wake-up command and a method of waking up the RFID tag.

The present invention also provides an RFID tag having a driving unit capable of expanding lifecycle of a built-in battery and a method of driving the RFID tag.

According to an aspect of the present invention, there is provided an RFID tag comprising: a general command decoder which decodes a signal received from an RFID tag reader to detect a general command; a wake-up command decoder which decodes the signal to detect a wake-up command; a main controller of which state is changed from an activated mode where the main controller activates the general command decoder and executes the general command to a standby mode where the main controller inactivates the general command decoder if the main controller does not receives the general command from the general command decoder within a predetermined time interval; and a wake-up controller which changes the state of the main controller from the standby mode to the activated mode if a voltage of a continuous wave included in the signal is equal to or higher than a predetermined voltage or if the wake-up command matches with a predetermined activation code.

According to another aspect of the present invention, there is provided an RFID tag comprising: a built-in battery; a voltage multiplier which rectifies and boosts a voltage of a signal received from an RFID tag reader to output a voltage of a detected continuous wave; and a switching circuit which applies a higher one between the voltage of the continuous wave and a voltage of the battery to internal components of the RFID tag.

According to another aspect of the present invention, there is provided a method of waking up an RFID tag, comprising: (a) detecting a general command by decoding a signal received from an RFID tag reader; (b) detecting a wake-up command by decoding the signal; (c) changing an activated mode where the general command decoder is activated and the general command is executed to a standby mode where the general command decoder is inactivated if the general command is not received from the general command decoder within a predetermined time interval; and (d) changing a state of a main controller from the standby mode to the activated mode if a voltage of a continuous wave obtained by rectifying and boosting a voltage of the signal is equal to or higher than a predetermined voltage or if the wake-up command matches with a predetermined activation code.

According to another aspect of the present invention, there is provided a method of supplying power to an RFID tag, comprising: rectifying and boosting a voltage of a signal received from an RFID tag reader to output a DC voltage; and applying a higher one between the DC voltage and a voltage of a built-in battery to internal components of the RFID tag.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram showing function blocks of a tag chip in a conventional passive radio frequency identification (RFID) tag;

FIG. 2A shows an activation command which is transmitted from an RFID tag reader to wake up an RFID tag according to an embodiment of the present invention;

FIG. 2B shows an encoding scheme for the activation command which is transmitted from the RFID tag reader to wake up the RFID tag according to the embodiment of the present invention;

FIG. 3 is a block diagram showing function blocks of an RFID tag according another embodiment of the present invention; and

FIG. 4 is a flowchart of a method of waking up an RFID tag according to another embodiment of the present invention.

### DETAILED DESCRIPTION OF THE INVENTION

Hereinafter, a face descriptor generating apparatus according to an embodiment of the present invention is described in detail with reference to the accompanying drawings.

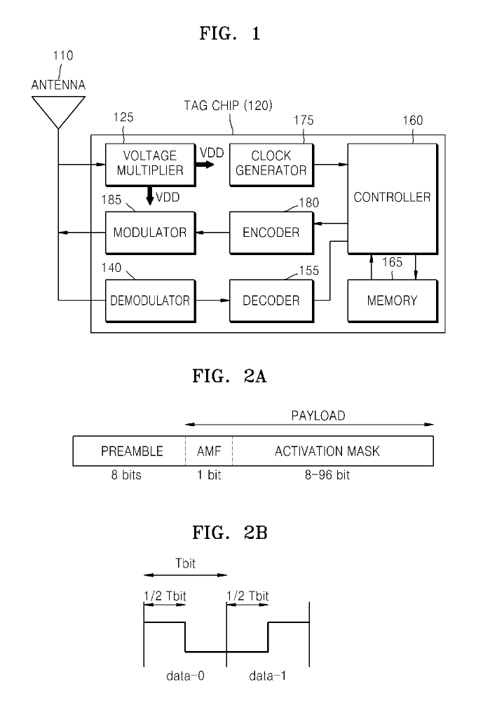

FIG. 2A shows an activation command which is transmitted from a radio frequency identification (RFID) tag reader to wake up an RFID tag according to an embodiment of the present invention.

Referring to FIG. 2A, a wake-up command (activation command) includes a preamble, an activation mask flag (AMF), and an activation mask (AMSK). Generally, an activation code stored in the RFID tag has a size of 8 bits to 96 bits. It is determined whether or not the activation code matches with the activation mask of the wake-up command.

FIG. 2B shows an encoding scheme for the activation command which is transmitted from the RFID tag reader to wake up the RFID tag according to the embodiment of the present invention.

Referring to FIG. 2B, the wake-up command of FIG. 2A is encoded using Manchester encoding scheme. A wake-up command decoder in the RFID tag decodes a signal received from an RFID tag reader, so that the wake-up command is detected.

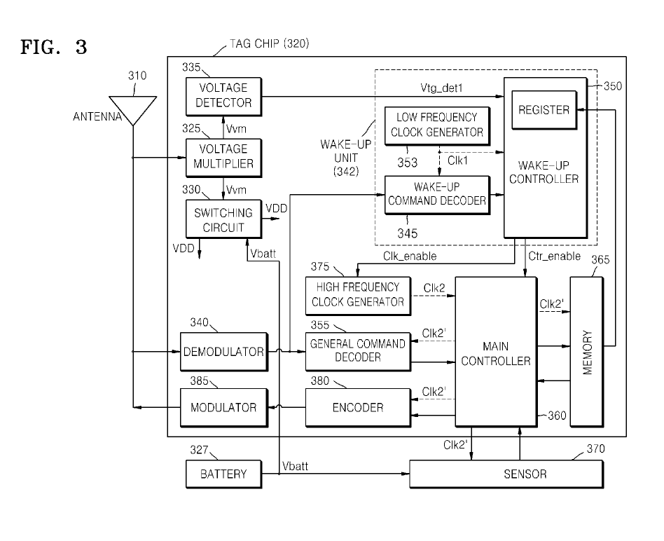

FIG. 3 is a block diagram showing function blocks of a battery-powered RFID tag according another embodiment of the present invention.

The battery-powered RFID tag includes an antenna 310, a tag chip 320, a battery 327, and a sensor 370. The tag chip 320 includes a voltage multiplier 325, the battery 327, a switching circuit 330, a voltage detector 335, a demodulator 340, a wake-up unit 342, a general command decoder 355, a main controller 360, a memory 365, the sensor 370, a high frequency clock generator 375, an encoder 380, and a modulator 385. The wake-up unit 342 includes a wake-up command decoder 345, a wake-up controller 350, and a low frequency clock generator 353. The antenna 310 receives a signal from the RFID tag reader and transmits the signal to the RFID tag chip 320. The signal includes a continuous wave and modulated signals of commands (a wake-up command and general commands) of the RFID tag reader.

The voltage multiplier 325 rectifies and boosts the signal to output a DC voltage Vvm of the detected continuous wave. When the DC voltage Vm is higher than a predetermined voltage Vth, the voltage detector 335 generates a signal Vtg_det1 to activate the RFID tag. The predetermined voltage Vth is a DC voltage which is high enough to activate the RFID tag. Due to the wake-up operation, the battery-powered RFID tag can communicate with a passive Gen2 RFID reader.

The switching circuit 330 compares the voltage output from the voltage multiplier 325 with a voltage Vbatt of the battery 327 built in the RFID tag to select the higher voltage and provides the higher voltage as a driving voltage VDD for internal components of the RFID tag. Accordingly, the voltage VDD provided to the RFID tag can be maintained in a voltage equal to or higher than the voltage Vbatt of the battery 327.

The demodulator 340 demodulates a signal received from the RFID tag reader, and the wake-up command decoder 345 decodes the demodulated signal to detect the wake-up command. The general command decoder 355 decodes the demodulated signal to detect the general commands.

The wake-up controller 350 compares the activation mask included in the wake-up command with the activation code stored in the register of the wake-up controller 350 to determine whether or not the activation mask matches with the activation code.

The wake-up controller 350 activates the RFID tag in two cases. The first case is that the voltage of the continuous waves detected by the voltage detector 335 is higher than the predetermined voltage Vth (that is a case where the signal Vtg_det1 is received from the voltage detector 335). The second case is that the activation mask included in the wake-up command matches with the activation code.

In the two cases, the wake-up controller 350 transmits a signal ctr_enable to the main controller 360 to activate the main controller 360 and a signal clk_enable to the high frequency clock generator 375 to activate the high frequency clock generator 375.

In turn, the activated main controller 360 activates the general command decoder 355, the memory 365, the sensor 370, the encoder 380, and the modulator 385. As a result, the RFID tag performs sensing, storing the sensed information, and executing the general commands received from the RFID tag reader and transmits the result of execution to the RFID tag reader.

The internal components (the general command decoder 355, the main controller 360, the memory 365, the sensor 370, the high frequency clock generator 375, the encoder 380, and the modulator 385) for executing the commands received from the RFID tag reader and transmitting the result of execution need to be in the inactivated state before the wake-up. On the other hand, the components for detecting the wake-up command transmitted from the RFID tag reader need to be maintained in the activated state. According to the embodiment of the present invention, in order to minimize power consumption in the standby mode, the decoder is divided into the wake-up command decoder 345 and the general command decoder 355, and the controller is divided into the wake-up controller 350 and the main controller 360. Therefore, only the components for the wake-up can be operated in the standby mode for minimizing power consumption.

In addition, since the power consumption increases as the frequency of the clock generator increases, the clock generator is divided into the low frequency clock generator 353 and the high frequency clock generator 375. In the standby mode, only the low frequency clock generator 353 is operated so as to operate only the components for the wake-up. On the other hand, the high frequency clock generator 375 provides a high frequency clock signal to the main controller 360 if the wake-up controller 350 generates the signal clk_enable. As described above, the wake-up controller 350 generates the signal clk_enable if the voltage of the continuous wave received from the RFID tag reader is higher than the predetermined voltage or if the wake-up command received from the RFID tag reader matches with the activation code stored in the RFID tag.

As an example of the embodiment of the present invention, a low frequency clock generator for generating a 32.768 KHz clock signal and a high frequency clock generator for generating a 1.92 MHz clock signal may be used.

According to the embodiment of the present invention, the wake-up controller 350 wakes up the RFID tag according to whether or not the activation mask included in the wake-up command transmitted from the RFID tag reader matches with the activation code. The activation code of the RFID tag is stored in such a memory 365 as EEPROM. If the EEPROM 365 is activated to perform the comparison of the activation code at every time that the wake-up command is transmitted from the RFID tag reader, much power is consumed. In order to reduce the power consumption, the wake-up controller 350 copies the activation code from the EEPROM 365 in an initialization period, that is, a period of initialization of the RFID tag and stores the activation code in the internal register.

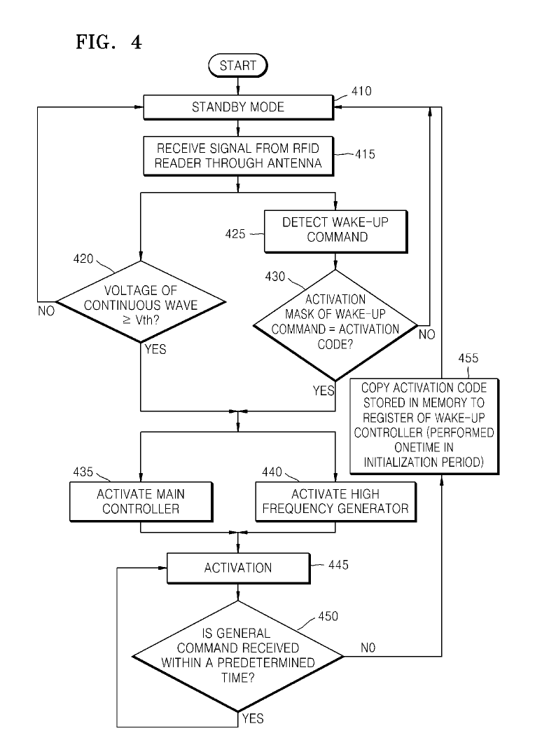

FIG. 4 is a flowchart of a method of waking up an RFID tag according to another embodiment of the present invention.

Referring to FIGS. 3 and 4, until the signal is transmitted from the RFID tag reader to the RFID tag, the general command decoder 355, the main controller 360, the memory 365, the sensor 370, the high frequency clock generator 375, the encoder 380, the modulator 385 of the RFID tag are maintained in the inactivated state, that is, the standby mode in operation 410. When the signal is received from the RFID tag reader in operation 415, the RFID tag may be woken up by using two schemes.

In the first wake-up scheme, it is determined whether or not the DC voltage formed by multiplying a voltage of the continuous wave included in the signal received from the RFID tag reader is equal to or higher than the predetermined voltage Vth. If the DC voltage is lower than the predetermined voltage Vth, the RFID tag is maintained in the standby mode. If the DC voltage is equal to or higher than the predetermined voltage Vth, the wake-up controller 350 outputs the signal Vtg_det1 so as to activate the RFID tag in operation 420.

In the second wake-up scheme, when the wake-up command is received from the RFID tag reader in operation 425, it is determined whether or not the activation mask included in the wake-up command matches with the activation code unique to the RFID tag stored in the register of the wake-up controller 350 in operation 430. If the activation mask does not match with the activation code, the RFID tag is mainlined in the standby mode. If the activation mask matches with the activation code, the wake-up controller 350 outputs the signal ctr_enable to the main controller 360 to activate the main controller 360 in operation 435 and the signal clk_enable to the high frequency clock generator 375 to activate the high frequency clock generator 375 in operation 440.

When the activated main controller 360 changes the state of the RFID tag into the activated mode, the RFID tag performs sensing, storing the sensed information, and executing the commands and transmits the result of execution to the RFID tag reader in operation 445. The main controller 360 determines whether or not an additional command is received within a predetermined time interval in operation 450. If the additional command is determined not to be received, the state of the main controller 360 is changed into the standby mode in operation 410.

Before the state of the main controller 360 is changed from the activated mode to the standby mode, the activation code stored in the memory 365 is copied in the register of the wake-up controller 350. The operation is performed onetime in the initialization period. Before the activation code is copied in the register, the activation code cannot be compared with the activation mask included in the wake-up command. Therefore, only the first wake-up scheme corresponding to the case where the voltage of the continuous waves received from the RFID tag reader is equal to or higher than the predetermined voltage is available.

According to the present invention, only the minimal components are operated to waking up an RFID tag from a standby mode thereof, so that it is possible to expand a lifecycle of a battery built in the RFID tag.

In addition, when a voltage of a continuous wave received from the RFID tag is sufficient, the voltage of the continuous waves instead of a voltage of the built-in battery is used, so that it is possible to expand the lifecycle of the battery.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. An RFID tag comprising:
a general command decoder which decodes a signal received from an RFID tag reader to detect a general command;
a wake-up command decoder which decodes the signal to detect a wake-up command;
a main controller of which state is changed from an activated mode where the main controller activates the general command decoder and executes the general command to a standby mode where the main controller inactivates the general command decoder if the main controller does not receives the general command from the general command decoder within a predetermined time interval; and
a wake-up controller which changes the state of the main controller from the standby mode to the activated mode if a voltage of a continuous wave included in the signal is equal to or higher than a predetermined voltage or if the wake-up command matches with a predetermined activation code.

2. The RFID tag of claim 1, further comprising a switching circuit which provides a higher one between the voltage of the continuous wave and a voltage of a built-in battery to the general command decoder, the wake-up command decoder, the main controller, and the wake-up controller.

3. The RFID tag of claim 1, further comprising:
a low frequency clock generator which generates a clock signal for operating the wake-up command decoder and the wake-up controller; and
a high frequency clock generator which generates a clock signal having a frequency higher than that of the clock signal generated by the low frequency clock generator and provides the high frequency clock signal to the main controller,
wherein the wake-up controller activates the high frequency clock generator if the voltage of the continuous wave is equal to or higher than the predetermined voltage or if the wake-up command matches with the predetermined activation code.

4. The RFID tag of claim 1, further comprising an encoder which encodes a result of general command execution of the main controller,
wherein the main controller in the activated mode activates the encoder.

5. The RFID tag of claim 1, further comprising:
a demodulator which demodulates the signal received from the RFID tag reader and transmits the demodulated signal to the wake-up decoder and the general command decoder; and
a modulator which modulates a result of general command execution of the main controller and transmits the modulated result to the RFID tag.

6. The RFID tag of claim 1, further comprising a voltage multiplier which rectifies and boosts the signal to output a DC voltage to the wake-up controller.

7. The RFID tag of claim 1, further comprising a memory, wherein the main controller in the activated mode activates the memory.

8. The RFID tag of claim 7,
wherein the memory stores the activation code and
the wake-up controller stores the activation code stored in the memory to a register of the wake-up controller in an initialization period and if the voltage of the continuous wave is equal to or higher than the predetermined voltage, before storing the activation code in the register, changes the state of the main controller into the activated mode without comparison of the wake-up command with the activation code.

9. The RFID tag of claim 7, further comprising a sensor which is driven by the built-in battery to sense environment information, wherein the main controller in the activated mode activates the sensor and stores the sensed environment information in the memory.

10. A method of waking up an RFID tag, comprising:
(a) detecting a general command by decoding a signal received from an RFID tag reader;
(b) detecting a wake-up command by decoding the signal;
(c) changing an activated mode where the general command decoder is activated and the general command is executed to a standby mode where the general command decoder is inactivated if the general command is not received from the general command decoder within a predetermined time interval;
(d) changing a state of a main controller from the standby mode to the activated mode if a voltage of a continuous wave obtained by rectifying and boosting the signal is equal to or higher than a predetermined voltage or if the wake-up command matches with a predetermined activation code.

11. The method of claim 10, further comprising applying a higher one between the voltage of the continuous waves and a voltage of a built-in battery.

12. The method of claim 10, further comprising:
generating a clock signal used to detect the wake-up command and determine whether to change the standby mode to the activated mode; and
generating a high frequency clock signal having a frequency higher than that of the clock used to execute the general command in the activated mode.

13. The method of claim 10, further comprising encoding a result of general command execution in the activated mode.

14. The method of claim 10, further comprising:
demodulating the signal; and
modulating a result of general command execution in the activated mode and transmitting the modulated result to the RFID tag reader,
wherein (a) comprises detecting the general command by decoding the demodulated signal, and
wherein (b) comprises detecting the wake-up command by decoding the demodulated signal.

15. The method of claim 10, further comprising rectifying and boosting the signal to output a DC voltage,
wherein (d) comprises changing the standby mode to the activated mode if the DC voltage is equal to or higher than a predetermined voltage or the detected wake-up command matches with a predetermined activation code.

16. The method of claim 10, wherein (d) comprises:
storing an activation code stored in a memory in a register in an initialization period;
changing the standby mode to the activated mode without comparison of the wake-up command with the activation code if the voltage of the continuous wave is equal to or higher than the predetermined voltage before the activation code is stored in the register; and
changing the standby mode to the activated mode if the voltage of the continuous wave received from the RFID tag reader is equal to or higher than the predetermined voltage or if the detected wake-up command matches with the activation code after the activation code is stored in the register.

17. The method of claim 10, further comprising sensing environment information in the activated mode and storing the sensed environment information in a memory.

18. An RFID tag comprising:
a built-in battery;
a voltage multiplier which rectifies and boosts a signal received from an RFID tag reader to output a voltage of a detected continuous wave; and
a switching circuit which applies a higher one between the voltage of the continuous wave and a voltage of the battery to internal components of the RFID tag.

19. A method of supplying power to an RFID tag, comprising:
rectifying and boosting a signal received from an RFID tag reader to output a DC voltage; and
applying a higher one between the DC voltage and a voltage of a built-in battery to internal components of the RFID tag.
